(19) United States
(12) Patent Application Publication
(10) Pub. No.: US 2014/0314396 A1
(43) Pub. Date: Oct. 23, 2014

(54) ELECTROTHERMAL ELEMENT

(71) Applicants: Chih-Ming Hsu, Taipei (TW); Shang-Lin Tsai, Taipei (TW); Chi-Lon Chen, Taipei (TW); Ming-Tsun Kuo, Taipei (TW); Huang-Sheng Liu, Taipei (TW); Yung-Hui Hung, Taipei (TW); Cheng-Pi Lee, Taipei (TW)

(72) Inventors: Chih-Ming Hsu, Taipei (TW); Shang-Lin Tsai, Taipei (TW); Chi-Lon Chen, Taipei (TW); Ming-Tsun Kuo, Taipei (TW); Huang-Sheng Liu, Taipei (TW); Yung-Hui Hung, Taipei (TW); Cheng-Pi Lee, Taipei (TW)

(21) Appl. No.: 13/867,980

(22) Filed: Apr. 22, 2013

(51) Int. Cl. H05B 3/00; F24H 3/00

(52) U.S. Cl. CPC H05B 3/008; F24H 3/002
USPC 392/376

(57) ABSTRACT

The present invention proposes an electrothermal element which comprises a substrate, a reflective layer, an electrothermal layer, and an auxiliary layer. The electrothermal layer can emit infrared radiation which is reflected by the reflective layer and enable infrared radiation emitted from one side of the electrothermal element. The auxiliary layer can increase the thermal uniformity of the electrothermal element and also convert the thermal energy of the electrothermal element itself into infrared radiation. It not only improves overall infrared emissivity of the electrothermal element but also reduces the temperature of the electrothermal element. This invention offers an effectively and rapidly warming up solution at selected local regions, no oxygen consumption and fan noise problems, and the electrothermal element can replace the traditional ceiling or be mounted directly on the wall, to solve the disadvantage of requiring space of the conventional electric heating device.

### FIELD OF THE INVENTION

The present invention relates to an electrothermal element, and more particularly to an electrothermal element with better infrared emissivity, which can be used as a heat source of heater and installed in the ceiling or mounted directly on the wall.

### BACKGROUND OF THE INVENTION

Heater is indispensable in many high latitude countries. Even in a subtropical country like Taiwan, people still need a heater to warm up the temperature in the room. The heaters available in the current market, depending on the way of heating, can be categorized in two different kinds, one is air type heater, and one is radiation type heater. To produce hot air, the air type heater heats the air around the thermal object, and with a fan, to spread the hot air allover the room. Typical air type heaters are ceramic heater, blade-type heater and kerosene radiant heater. The radiation type heater produces heat with the thermal element which is able to emit infrared radiation to warm up the target or the air in a room. The typical radiation type heaters include quartz-tube heater, tungsten lamp heater and halogen lamp heater.

However, the typical disadvantages of air type heater are heating slowly and consuming electrical power, and some of products also exhausting oxygen and making noise. While the radiation type heater although is heating faster but life of product is usually short, and because it's consuming more oxygen, the ventilation become an issue. Other disadvantage of the radiation type heater is that it's emitting red light when operation, which causes disturbance to a sleeper. Normally, no matter which type heater being used, it's hard to match the interior decoration most time so as to become interference in interior design.

### SUMMARY OF THE INVENTION

In order to cure the disadvantages of traditional heaters described above, the present invention discloses an electrothermal element which is heating faster, without consuming oxygen, with no noise made by fan, occupying less space. The electrothermal element comprises a substrate, which is the main portion of the electrothermal element and can be an object of plate or board; an electrothermal layer, which has electrodes deposited thereon and produces heat and emits infrared radiation when connected electrically; a reflective layer for reflecting infrared radiation from one side of the electrothermal element; and an auxiliary layer which is high thermal conductive, for spreading the heat evenly and converting some portion of thermal energy into infrared radiation so as to enhance the emissivity of infrared radiation of the electrothermal element.

In addition to the advantages described above, the electrothermal element of the present invention also has the following advantages.
(1) Heating the target with the infrared radiation, which is much faster than the air type heater.
(2) Operating without fan so as to low down the noise.
(3) Comparing with the quartz-tube heater, tungsten lamp heater and halogen lamp heater, the operating temperature is low, without the problem of consuming oxygen, life of product is longer, and more safe.
(4) Without emitting visible light when in operation to cause interference to the sleeper.
(5) The electrothermal element itself is a thin plate or board which can be easily installed in the ceiling or on the wall, and occupying less space than the traditional stand heater.
(6) The electrothermal element of the present invention is employing the infrared radiation which enhance the ventilation of blood of human's body, that is, medical effect is excellent, therefore, the present invention is not limited to be used in winter time.
(7) The electrothermal element of the present invention radiates infrared radiation more efficient so as to consuming less electrical power to save energy.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic cross-sectional view showing the electrothermal element according to a preferred embodiment of the present invention.

FIG. 2 is a schematic top view showing the electrothermal layer according to a preferred embodiment of the present invention.

FIG. 3 illustrates the transparent reflective layer formed with different doped ZnO films stacked alternatively according to a preferred embodiment of the present invention.

FIG. 4A is a schematic cross-sectional view showing the electrothermal element according to a preferred embodiment of the present invention.

FIG. 4B is a schematic cross-sectional view showing the electrothermal element according to a preferred embodiment of the present invention.

FIG. 4C is a schematic cross-sectional view showing the electrothermal element according to a preferred embodiment of the present invention.

FIG. 4D is a schematic cross-sectional view showing the electrothermal element according to a preferred embodiment of the present invention.

FIG. 5A is a schematic cross-sectional view showing the electrothermal element according to a preferred embodiment of the present invention.

FIG. 5B is a schematic cross-sectional view showing the electrothermal element according to a preferred embodiment of the present invention.

### DETAILED DESCRIPTION OF THE PREFERRED EMBODIMENTS

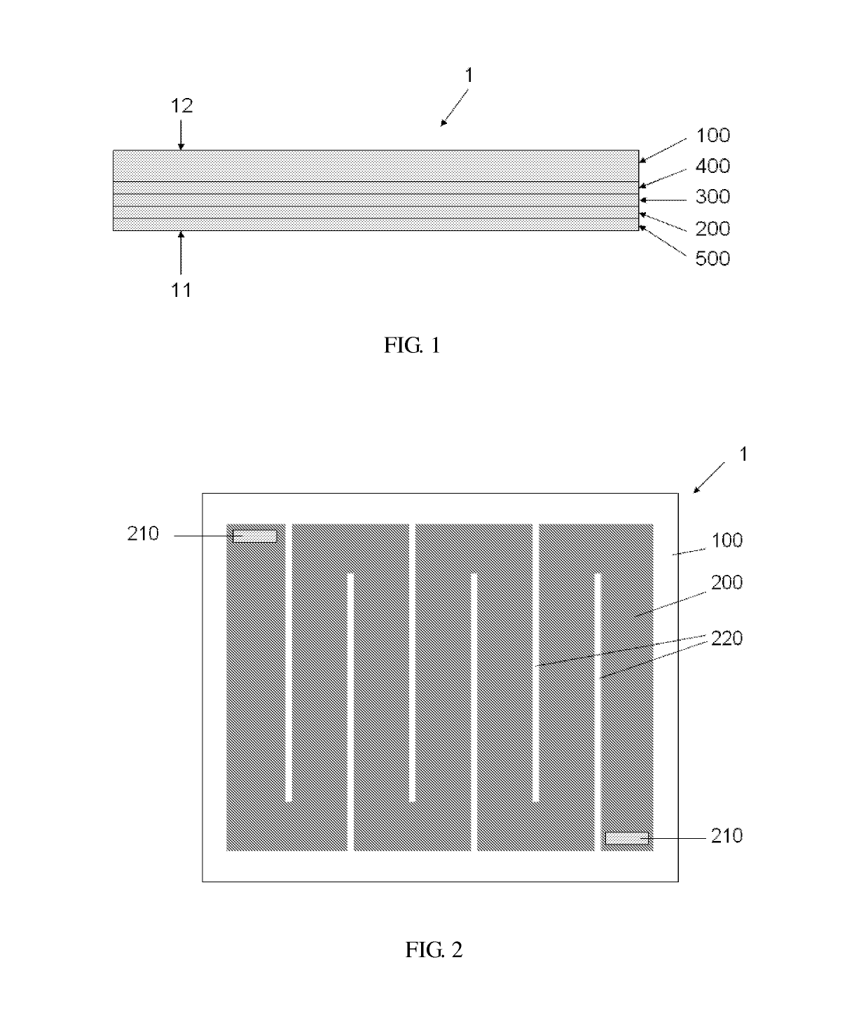

Please refer to FIG. 1, which is the first embodiment of the present invention. In FIG. 1, the present invention discloses an electrothermal element 1 which comprises a substrate 100 in shape of board or plate, and the substrate 100 can be made of the materials of glass, micro-crystal glass, ceramic or carbon fiber. A reflective layer 400 is deposited on the substrate 100 for reflecting the infrared radiation; the layer can be made of high conductivity metals like gold, silver, copper or aluminum. An auxiliary layer 300 is deposited on the reflective layer 400 for increasing the thermal uniformity of the electrothermal element 1 and also convert the thermal energy of the electrothermal element 1 itself into infrared radiation, which decreases the temperature of the electrothermal element 1 so as to decrease the un-stability of the electrothermal element 1 caused by the temperature, and increase the emissivity of infrared, also stop the aging of the electrothermal element 1 caused by the ion permeation from the substrate (or other layers) to the electrothermal element 1. The auxiliary layer 300 has the properties of high thermal conductivity and emitting infrared radiation, which can be made of diamond, diamond powder, diamond-like film or diamond-like carbon (DLC) film. An electrothermal layer 200 is deposited on the auxiliary layer 300 which produces heat and emits infrared when being connected electrically, and the electrothermal layer 200 can be made of conductive metal oxides like tin oxide (SnO₂), indium tin oxide (ITO) or zinc oxide (ZnO). An electrode 210 is deposited on the electrothermal layer 200 for being connected electrically. The value of electric resistance of the electrothermal layer 200 can be determined by changing the thickness of the layer or by changing the resistivity of the material in production process, or by etching pattern 220 on the electrothermal layer 200 to form an electrical layout. A protective layer 500 is deposited on the electrothermal layer 200, which can be transparent or non-transparent, for protecting the electrothermal layer 200 from the air, also protecting the object or people from electrical shock. The protective layer 500 can be made of polymeric materials, or the materials used in the auxiliary layer 300 like diamond, diamond powder, diamond-like film or diamond-like carbon (DLC) film so the layer can function as both the protective layer 500 and the auxiliary layer 300.

As described above, the electrothermal layer 200 produces heat and emits infrared when being connected electrically, the auxiliary layer 300 increases the thermal uniformity and also converts the thermal energy of the electrothermal element itself into infrared radiation, and the reflective layer 400 reflects the infrared radiation efficiently, so, most infrared radiation emits from a first side 11 of the electrothermal element. Because of the advantages described above, the electrothermal element of the present invention is easily installed in the ceiling or on the wall and occupies less space, or can be integrated with the interior design, and the temperature generated by the electrothermal element's is low when in operation, other advantages includes no oxygen consumption and no noise made by fan.

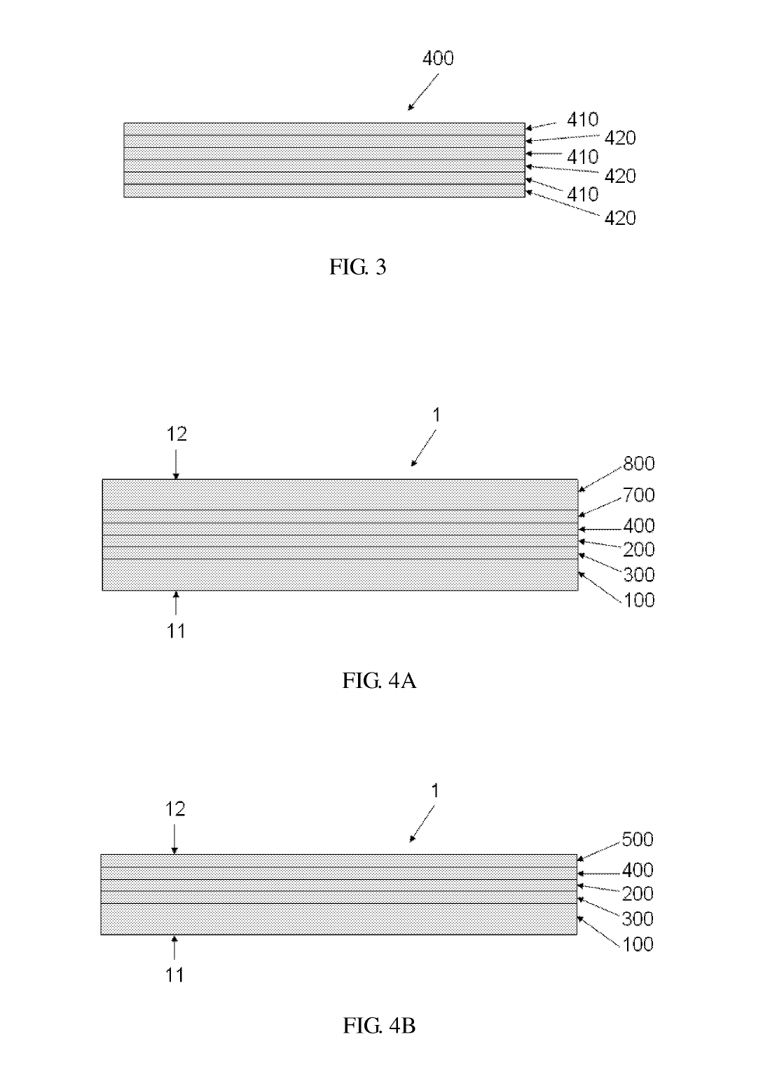

The structure of the second embodiment of the present invention has the similar structure of the first embodiment of the present invention. Please refer to FIG. 1, which is showing the second embodiment of the present invention, in which the reflective layer 400 is replaced with a transparent and conductive material, such as, transparent conductive films including SnO₂, ITO, or ZnO, and in this embodiment, ZnO film is used. More particularly, according to the optical theory, the light is reflected at the interface of different materials with different refractive indices. For infrared light, the refractive index of ZnO film is significantly affected by doping levels. A transparent reflective layer 400 (shown in FIG. 3) which is transparent in visible light, but high-reflecting in infrared light can be prepared by alternatively stacking different doped ZnO films, such as intrinsic ZnO 410 and doped ZnO 420. So that, the reflective layer 400 made of different transparent conductive materials, the electrothermal element of the present invention can be an electrothermal element with high transparent index in visible light.

The structure of the third embodiment of the present invention is based on the similar structure of the first embodiment of the present invention, but forming a pattern layer (not shown) on a side 11 of the electrothermal element by printing or sticking to improve the looking of the electrothermal element in order to match the style of interior design when the electrothermal element is installed in the ceiling or on the wall. The pattern layer can be used with thermochromic materials whose color is subjected to the temperature, that is, the temperature change of the electrothermal element will also change the color of the out-looking of the electrothermal element, such feature can be used as an indication of operation or scenario expression. More, the pattern layer can function as a protective layer when the pattern layer is made of insulating material, and when the electrothermal element is transparent with respect to visible light, the pattern layer can be deposited on a second side 12 of the electrothermal element.

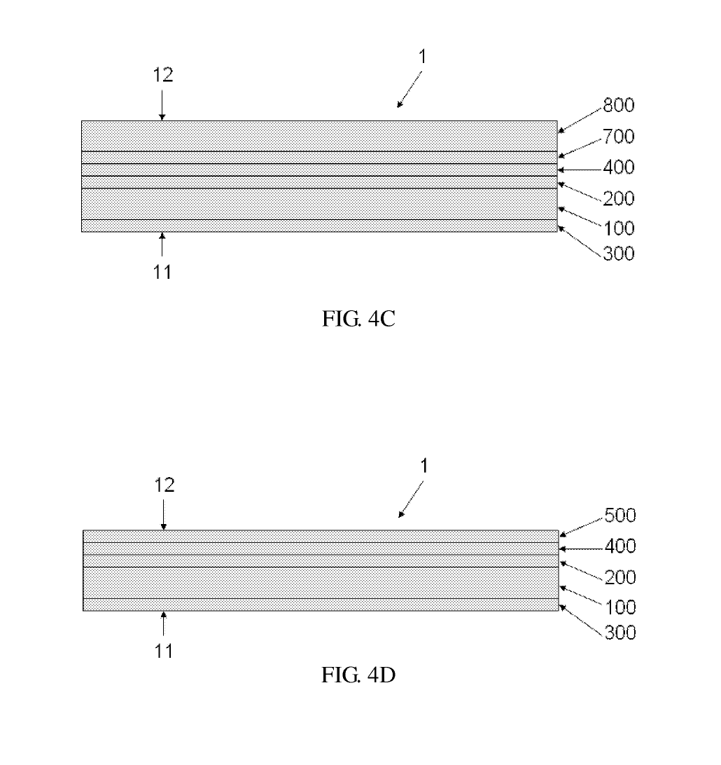

The forth embodiment of the present invention is shown in FIG. 4A. In FIG. 4A, the present invention discloses an electrothermal element 1 which comprises a substrate 100 in shape of board or plate, and can be made of the materials of glass, micro-crystal glass, ceramic or carbon fiber. A auxiliary layer 300 is deposited on the substrate 100 for increasing the thermal uniformity of the electrothermal element 1 and also convert the thermal energy of the electrothermal element 1 itself into infrared radiation, which decreases the temperature of the electrothermal element 1 so as to decrease the un-stability of the electrothermal element 1 caused by the temperature, and increase the emissivity of infrared, also stop the aging of the electrothermal element 100 caused by the ion permeation from the substrate (or other layers) to the electrothermal element 1. The auxiliary layer 300 is high thermal conductive and emitting infrared radiation, which can be made of diamond, diamond powder, diamond-like film or diamond-like carbon (DLC) film. An electrothermal layer 200 is deposited on the auxiliary layer 300 which produces heat and emits infrared when being connected electrically, and the electrothermal layer 200 can be made of conductive metal oxides like SnO₂, ITO, or ZnO. An electrode 210 is deposited on the electrothermal layer 200 for being connected electrically, and the etching pattern 220 is made on the electrothermal layer 200 for adjusting the value of electric resistance. A reflective layer 400 is deposited on the electrothermal layer 200 for reflecting the infrared radiation; the layer can be made of metals with high conductivity like gold, silver, copper or aluminum. More, the reflective layer 400 can be made to be transparent as illustrated in the second embodiment of the present invention, in which the electrothermal element is a transparent element with respect to visible light. Further, in this forth embodiment, the electrothermal element also comprises a back plate 800 that can be made of the materials of glass, micro-crystal glass, ceramic or carbon fiber. With an adhesive layer 700, such as PVB or EVA, the back plate 800 can be combined with the substrate 100. Otherwise, the back plate 800 and the adhesive layer 700 can be replaced together with a protective layer as described in the first embodiment (shown in FIG. 4B).

The fifth embodiment of the present invention is shown in FIG. 4C, and the structure thereof is similar to that in the forth embodiment of the present invention. In FIG. 4C, the auxiliary layer 300 is deposited on surface 11 of the substrate 100. Since the auxiliary layer 300 is made of diamond, diamond powder, diamond-like film or diamond-like carbon (DLC) film, which not only has the advantages like lowing down temperature, increasing thermal uniformity of the electrothermal element and increasing the emissivity of infrared, but also can function as a protective layer to protect the surface 11 of the substrate 100. Moreover, the back plate 800 and the adhesive layer 700 both can be replaced with a protective layer as described in the first embodiment (shown in FIG. 4D).

The sixth embodiment of the present invention is based on the forth and fifth embodiment of the present invention (shown in FIG. 4A, 4B, 4C and 4D), further forming a pattern layer on the surface 11 of the electrothermal element by printing or sticking to improve the looking of the electrothermal element in order to match the style of interior design when the electrothermal element is installed on the ceiling or on the wall. The pattern layer can be used with thermochromic materials whose color is subjected to the temperature, that is, the temperature change of the electrothermal element will also change the color of the out-looking of the electrothermal element, and such feature can be used as an indication of operation or scenario expression. Moreover, the pattern layer can function as a protective layer when the pattern layer is made of insulating material, and when the electrothermal element is transparent with respect to visible light, the pattern layer can be deposited on the surface 12 of the electrothermal element.

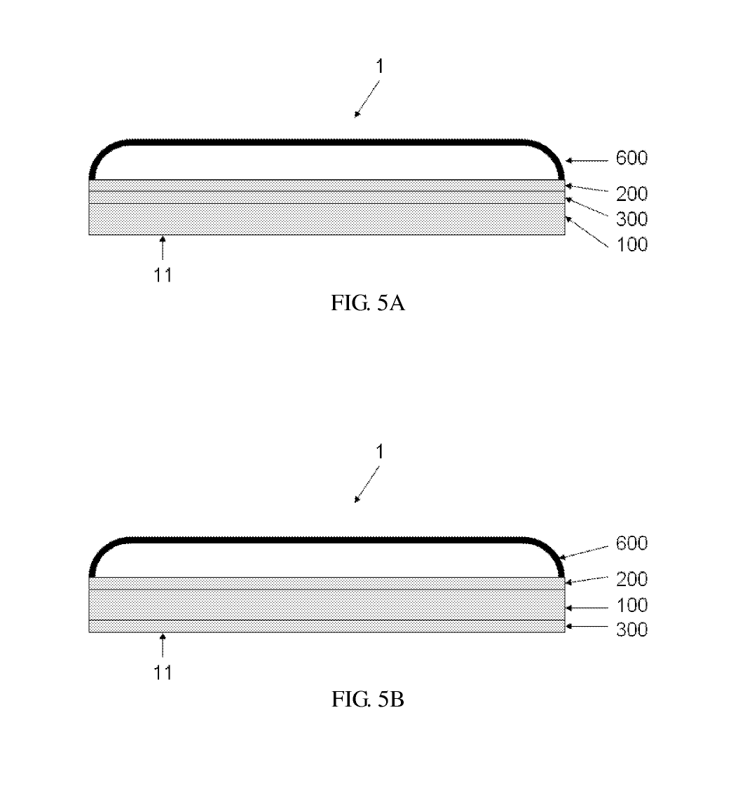

The seventh embodiment of the present invention is shown in FIG. 5A. In FIG. 5A, the auxiliary layer 300, the electrothermal layer 200 and a reflecting cover 600 cover on the substrate 100. The reflective cover 600 can be made of a metal plate or a metal cover, or a cover which of the inner side coated with metals. The function of the reflecting cover 600 is to reflect the infrared and providing protection. The materials of the reflecting cover is made by high conductivity metals, such as gold, silver, copper or aluminum. Moreover, the auxiliary layer is deposited on the surface 11 (as shown in FIG. 5B) of the electrothermal element. Since the auxiliary layer is made of diamond, diamond powder, diamond-like film or diamond-like carbon (DLC) film, which not only has the advantages like lowing down temperature, increasing thermal uniformity of the electrothermal element and increasing the emissivity of infrared, but also can function as a protective layer to protect the surface of the substrate. Furthermore, a pattern layer can be formed on the surface 11 of the electrothermal element by printing or sticking to improve the out-looking of the electrothermal element in order to match the style of interior design when the electrothermal element is installed on the ceiling or on the wall. The pattern layer can be used with thermochromic materials whose color is subjected to the temperature, that is, the temperature change of the electrothermal element will also change the color of the out-looking of the electrothermal element, and such feature can be used as an indication of operation or scenario expression.

The present invention has been described with some preferred embodiments thereof and it is understood that many changes and modifications in the described embodiments can be carried out without departing from the scope and the spirit of the invention that is intended to be limited only by the appended.

1. An electrothermal element, comprising a substrate as a main portion of the electrothermal element;
an electrothermal layer, having electrode deposited thereon, for generating heat and for emitting infrared when being connected electrically;
a reflecting layer for reflecting infrared; and
an auxiliary layer for increasing thermal uniformity and the emissivity of infrared for the electrothermal element.

2. The electrothermal element as claimed in claim 1, wherein the substrate is made of a material selected from the group consisting of glass, micro-crystal glass, ceramic or carbon fiber.

3. The electrothermal element as claimed in claim 1, wherein the reflecting layer is a metal film.

4. The electrothermal element as claimed in claim 1, wherein the reflecting layer is a metal oxidefilm.

5. The electrothermal element as claimed in claim 1, wherein the reflecting layer is a thin film made of zinc oxides.

6. The electrothermal element as claimed in claim 1, wherein the reflecting layer is made by stacking different zinc oxide films doped with different doping levels.

7. The electrothermal element as claimed in claim 1, wherein the reflecting layer is transparent with respect to visible light.

8. The electrothermal element as claimed in claim 1, wherein the electrothermal layer is a thin film made of zinc oxides.

9. The electrothermal element as claimed in claim 1, wherein the electrothermal layer has etched pattern thereon.

10. The electrothermal element as claimed in claim 1, wherein the auxiliary layer is a diamond-like carbon (DLC) film.

11. The electrothermal element as claimed in claim 1, wherein the electrothermal element has a pattern layer deposited thereon for improving the out-looking of the electrothermal element.

12. The electrothermal element as claimed in claim 11, wherein the pattern is made of thermochromic materials subjected to the temperature and changes color depending on the temperature for the indication of operation or scenario expression.
